(19) United States
(12) Patent Application Publication
(10) Pub. No.: US 2008/0202169 A1
(43) Pub. Date: Aug. 28, 2008

(54) Fibering Device, Particularly For Making Glass Fibers

(75) Inventors: Marco La Greca, Milano (IT); Roberto Massini, Bergamo (IT); Gerolamo Fasce, Genova (IT)

Correspondence Address: PEARNE & GORDON LLP, 1801 EAST 9TH STREET, SUITE 1200, CLEVELAND, OH, 44114-3108, US

(73) Assignee: TECHINT COMPAGNIA TECHNICA INTERNAZIONALE S.P.A., Milano (IT)

(21) Appl. No.: 11/908,240

(22) PCT Filed: Feb. 15, 2006
(86) PCT No.: PCT/IB06/00429

§ 371 Date: Mar. 13, 2008

(30) Foreign Application Priority Data
Mar. 11, 2005 (IT) MI2005A000388

(51) Int. Cl. C03B 37/04

(52) U.S. Cl. 65/461; 65/523

(57) ABSTRACT

It is provided a fibering device for making insulating glass fibers in which the gas fiber coming out of a rotor (3) driven in rotation around its axis is maintained to a viscous state and stretched by means of two blower units capable of directing the respective flows towards the fibers coming out of the rotor (3). The second blower unit (8) consists of a plurality of nozzles (10) for delivery of an air flow, which nozzles can be rotated about a respective axis (B) that is transverse to the rotation axis (A) of the rotor. Through movement of the nozzles (10), the point of incidence of the second flow (9) on the fibers is modified so that the stretching degree of the fibers is consequently varied.

The present inventions relates to a fibering device, particularly for making insulating glass fibers.

It is known that there are on the market and are presently used machines for producing an insulating glass fiber in which the rotor made of a special metal alloy, eccentrically and continuously fed with melted glass and being driven in rotation around an axis thereof, ejects primary glass threads, by centrifugal force, from a predetermined number of holes present in a side surface of the rotor itself, which threads are reduced into very thin fibers by suitable means with which the machine is equipped.

In more detail, an annular burner is generally present which is concentric with respect to the rotor and which, at the primary thread-exit region, is capable of creating the necessary temperature and pressure parameters designed to maintain the glass threads to the right viscosity adapted to enable subsequent stretching.

Actually, the stretching operation mostly relies on a blowing ring or crown fed with compressed air that is peripherally and concentrically active exactly at the exit region of the primary threads from the rotor. In this way, the compressed air flow acts on the fibers causing elongation of same and consequent thinning of the fiber section so as to obtain an insulating glass fiber having the required physical and mechanical features.

Also known are machines provided with an auxiliary blowing unit disposed alongside the blowing crown and set to generate a further air flow under pressure. In particular, the auxiliary blowing unit is made up of a nozzle having an annular opening facing the outer surface of the rotor and concentric with the rotation axis of the rotor itself.

The auxiliary blowing unit generates a pressurised flow directed downwardly and inclined to the rotation axis of the rotor. In this way, the combined flows of compressed air from the blowing crown and pressurised air generated by the nozzle produce an air flow of high pressure which is adapted to quickly stretch and separate the fibers coming out of the rotor.

However, the solution briefly described above has some operating limits.

It is to be pointed out first of all that the above machines do not appear to be particularly versatile.

It is known that in the fibering process the same rotor is used for many days, which involves an important modification in the shape of the produced-fiber torus due to wear of the holes from which the glass comes out.

The above drawback results in difficulties in evenly distributing the fiber in the collecting chamber and decay in the quality of the finished product.

Also the unavoidable physico-chemical variations in the melted glass give rise to the same negative effects. Under this situation, it will be recognised that known machines cannot be easily adapted to the operating parameters based on the type of glass to be fibered.

In addition, it is to be pointed out that under this situation known machines do not allow glass fibers to be produced which have an a priori-determined constant average length. In fact it was possible to notice that the angle and point of incidence of the air flows on the fibers, for the purpose of causing stretching, are subjected to variations due to modification of the spatial configuration of the outgoing material, and therefore they might not be optimal.

The present invention aims at substantially solving the above mentioned drawbacks.

It is a first aim of the invention to make available a fibering device capable of adapting itself to the type of material used and to the operating conditions of the machine.

It is a further aim of the invention to provide a fibering device capable of producing glass fibers of predetermined and variable lengths and diameters, depending on the production requirements.

The foregoing aims that will become more apparent in the course of the following description are substantially achieved by a fibering device in accordance with the invention.

Further features and advantages will be best understood from the detailed description of a fibering device in accordance with the appended claims.

A preferred but not exclusive embodiment of a fibering device, in particular for making glass fiber will be set out hereinafter with reference to the accompanying drawings, in which:

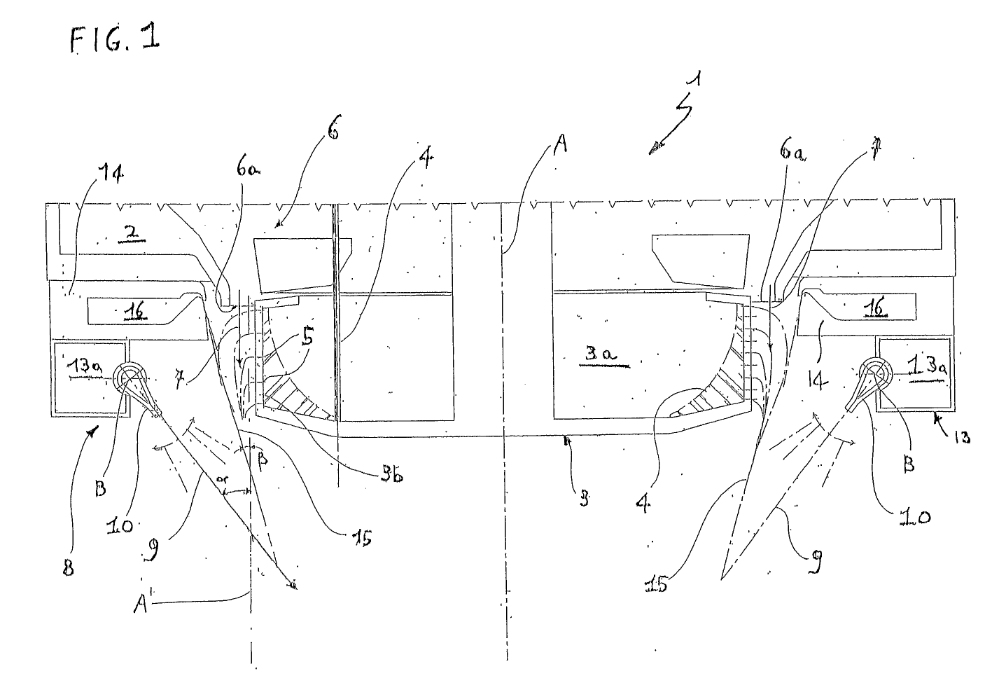

FIG. 1 is an elevation side view partly in section of the fibering device in accordance with the invention; and

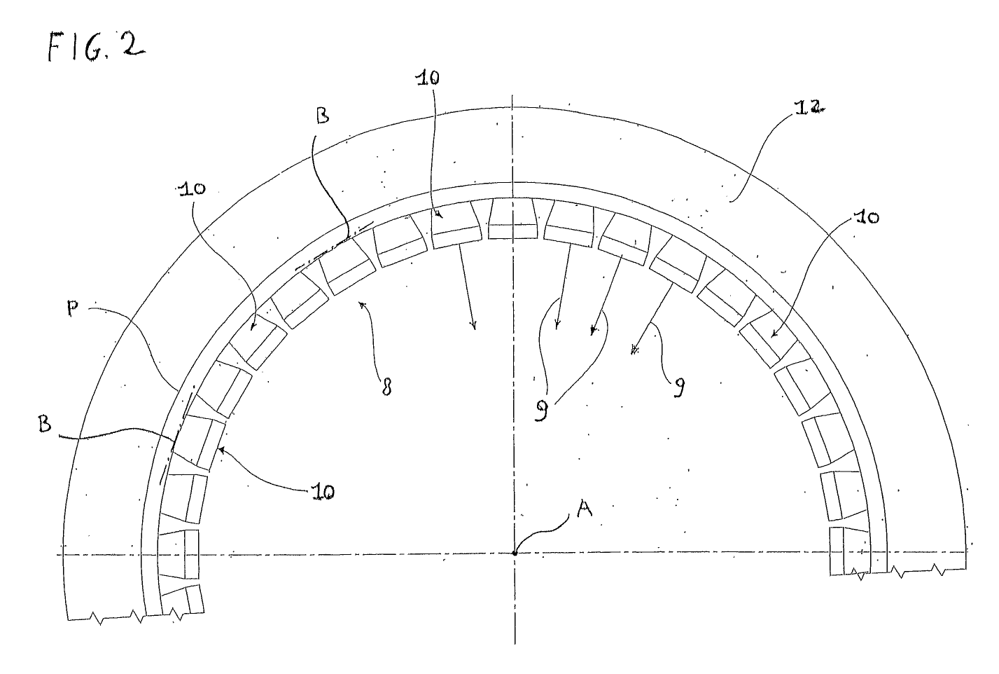

FIG. 2 is a diagrammatic plan view from the top of a construction detail of the device shown in FIG. 1.

With reference to the drawings, a fibering device, in particular for making insulating glass fibers for production of manufactured articles intended for thermal and acoustic insulation has been generally identified with reference numeral 1.

As can be viewed from FIG. 1, the fibering device comprises a bearing structure 2 with which a rotor 3 is engaged. This rotor 3 is in particular movable around a rotation axis A during operation of the device 1.

As can be seen still in FIG. 1, a material to be fibered 4 (generally a suitable glass composition to make glass fibers) is eccentrically fed into a cavity 3a defined in rotor 3.

Said rotor 3 on a peripheral side surface 3b thereof has a predetermined number of holes 5 suitably sized and spaced apart the same distance from each other to enable exit of the material 4 (by centrifugal effect) in the form of glass filaments, following rotation around said axis A.

Immediately adjacent to rotor 3 there is the presence of at least one annular burner 6 in engagement with the bearing structure 2, which is capable of directing a flow 7 of high-temperature burnt gases to the primary filaments coming out of rotor 3 so as to maintain the suitable viscosity conditions of the primary threads to enable the latter to be submitted to a stretching action.

In particular, burner 6 consists of an annular chamber disposed above rotor 3 and coaxial with the rotation axis A of the rotor 3 itself.

The annular chamber has an outlet 6a to direct the burnt gas flow 7 along a direction parallel to the rotation axis A of the rotor. In other words, the flow 7 made up of high-temperature burnt gases, is directed towards the primary filaments coming out of the rotor.

In this way (taking the temperature of flow 7 into account) the possibility of making the glass threads increasingly thinner is successfully ensured i.e. it is possible to lengthen the path along which the glass stays to a viscosity enabling it to be stretched.

Generally, the burner 6 too will have a stretching effect on the fiber, but the final thinning operation relies on the action of the compressed air.

The device 1 further has one blower unit 14 (of known type and described in the following) and a second blower unit 8 coaxial with burner 6, to generate the second compressed-air flow 9 active on the fiber material coming out of rotor 3.

Advantageously, the second blower unit 8 defined by a compressed-air blowing crown can be configured according to different operating positions to be selected by the operator depending on the production requirements.

Generally these operating positions are reached as a result of suitable rotations of the blower unit around an axis thereof (transverse to the rotation axis A of rotor 3) to vary the direction of the second flow 9.

In particular, the second blower unit 8 has at least one flow delivering nozzle 10 movable around a respective axis B lying in a plane perpendicular to the rotation axis A of the rotor.

More particularly, as shown in detail in FIG. 2, the second blower unit 8 has a plurality of nozzles 10 disposed in mutual side by side relationship along a circular path P concentric with the rotation axis A of rotor 3.

In this way, the second flow 9 generated by the second blower unit 8 is made up of the flows generated by each individual nozzle and has a substantially conical overall conformation converging downwardly.

Still referring to FIG. 2, it is possible to see that the rotation axis B of each individual nozzle 10 is tangential to said circular path P. Advantageously, following rotation of each nozzle 10, the orientation of the second flow 9 too is modified, as well as the angle by which this flow impinges on the fibers coming out of rotor 3.

Preferably, the Applicant has found an optimal operation where nozzles 10 provided with an outlet of a 30×0.15 mm size are used. It is further to be pointed out that nozzles 10 are suitably spaced apart from each other (see FIG. 2) to avoid them to impact against each other during their movements.

The device 1 further has actuating means to move the nozzles in a coordinated manner and in synchronism with each other. Advantageously, the coordinated movement of nozzles 10 causes a variation in the conical profile of the second flow 9.

It is to be pointed out that the actuating means, not shown in the accompanying drawings as they are of known type, can consist of any actuating member of the type widely used and designed for rotation of said nozzles. For example, said means can consist of a pneumatic system or of respective mechanical actuators and one or more motors governed by an electronic control box.

In addition, the device 1 is provided with a supporting member 12 of annular extension to carry said nozzles 10 in a circumferential arrangement. The supporting member 12 has a respective actuating system (not shown and described because it is of known type too) to vertically move the member 12 itself along a direction parallel to the rotation axis A. In this way, the nozzles 10 too are further moved (in addition to being driven in rotation) close to and away from rotor 3 to further vary the direction of the second flow 9.

Again, the second blower unit 8 has a source of compressed air 13 associated with each nozzle 10 to generate the second pressurised air flow 9. The source of compressed air 13 is connected to an annular duct 13 supported by the supporting member 12 too, to supply all nozzles 10 with air under pressure. In this way the second flow 9 suitably oriented carries out an additional stretching operation before the first stretching flow 15 has completed its action.

As shown in FIG. 1, the first stretching flow is generated by the fixed blowing crown 14. The compressed air flow is directed downwardly and is inclined to the rotation axis A of rotor 3.

In detail, blower 14 has an annular chamber 16 with an outlet for directing the flow 15. The outlet is close to and concentric with burner 6. This enables the flow 15 to be active on the glass fibers immediately downstream of rotor 3.

Advantageously, the primary filaments coming out of rotor 3 are firstly impinged on by the first burnt gas flow 7 keeping them to the suitable temperature and by the compressed air flow 15 drawing the fibers downwardly; subsequently, the fibers are impinged on by the second flow 9 carrying out a further stretching action on the fibers themselves.

In this way, the lengthened fibers are separated and they are sucked onto a holed collecting belt and disposed under the rotor 3 to a minimum distance of 3 metres.

The second flow 9 of the present invention will act on the fibers being formed as an additional stretching element before the action of the first flow 15 has come to an end.

After the above description with reference to the structure of the fibering device, the production method carried out by the machine shown in FIG. 1 is the following.

First of all the rotor 3 driven in rotation is eccentrically fed with glass melted to a temperature determining the right glass viscosity.

By centrifugal force the material is urged out of the holes 5 present in the side surface 3b of the rotor itself, in the form of primary glass filaments.

The annular burner 6 generates a burnt gas flow 8 that is active on the filaments to maintain the possibility of making them increasingly thinner by heat supply. In other terms the flow 7 consisting of high-temperature gas maintains the primary filaments to the suitable viscosity for the stretching action.

The blowing crown 14 generates the compressed air flow 15 which, co-operating with the burnt gas 7 action, draws the primary filaments coming out of rotor 3 and directs them downwards and under the rotor 3 itself.

The second blower unit 8 generates the second flow 9 that is active in carrying out the stretching action as well. Under this situation it will be recognised that the flow 15 is disposed between the burnt gases 7 and the second flow 9.

Advantageously, as mentioned above, the direction of the second flow 9 can be modified depending on the various production requirements and the geometry of the outgoing fibers. In detail, the second flow 9 is oriented by driving said second blower unit 8 in rotation around its axis B transverse to the rotation axis A of rotor 3.

The step of driving the second blower unit 8 in rotation is carried out through rotation of each nozzle 10 around the respective axis B tangent to the circular path P. Preferably, nozzles 10 are rotated in a coordinated manner and in synchronism to change the conical profile of the second flow 9. In this way, the second flow 9 that is directed downwardly and towards axis A of rotor 3 is oriented in such a manner that it will be more or less incident on the fibers coming out of the rotor.

Advantageously, the second flow 9 is oriented in such a manner that the ratio of angle β defined between the first flow 15 and the vertical axis A′ to angle α defined between the second flow 9 and the vertical axis A′ can continuously vary. In particular when this ratio is less than 0.6, short fibers of greater diameter are obtained. This type of glass fiber is adapted to make insulating products of greater density for particular applications. On the contrary, ratios in the range of 0.6 to 1.0 increase the stretching action, and longer and thinner fibers are obtained.

In the light of the above it is therefore possible to state that this ratio enables the stretching action carried out by flow 15 and flow 9 to be optimised.

Again, as mentioned above, the second blower unit 8 can be fully moved along a direction parallel to the rotation axis A of rotor 3. In this way, the second flow 9 will strike on the fibers coming out of rotor 3 at different points to impart a more or less stretching effect to the fibers themselves.

Advantageously, the combined effect between the rotation of each nozzle 10 and the vertical movement of the nozzles 10 themselves enables the direction of the second flow 9 to be further modified so as to modify not only the angle of incidence, but also the point at which the fibers are impinged on by the second flow 9.

It will be appreciated that in this manner the second flow 9 can be moved until a maximum point of incidence which is coincident with the point of incidence of the first flow 15.

The invention achieves important advantages.

First of all, the previously described fibering device enables the stretching action on the fibers coming out of rotor 3 to be modified to obtain fibers having varying features in terms of length and diameter.

In other words, the position of nozzles 10, i.e. the distance of the nozzles from rotor 3 in a vertical direction and the angle of said nozzles (i.e. the angle of the outgoing flow) can be easily modified in order to vary the effect of the second flow 9 on the fiber formation and consequently to determine a more or less important action.

The orientation of the second flow 9 can be modified also depending on the glass material to be used and the geometry of the fiber on its coming out of the rotor. In fact, depending on the physical features of the material, the nozzles 10 are suitably positioned to obtain fibers of the required diameter and length.

Advantageously, with the device 1 of the invention it is also possible to obtain either short and thick fibers which are used for producing articles of manufacture of important density for example, or longer fibers suitable for insulating products that for transport and storage need to be greatly compressed but that must then be able, on installation, to recover their original thickness thereby ensuring the declared thermal resistance.

1. A fibering device for making glass fibers comprising:
at least one rotor (3) set to receive a material to be fibered (4) inside the rotor and designed to be driven in rotation around its axis (A), said rotor (3) having a predetermined number of holes (5) in a surface thereof, which holes are designed to enable the material (4) to come out in the form of primary filaments;
at least one annular burner (6) producing a high-temperature flow (7) of burnt gases towards the primary filaments coming out of the rotor (3) and maintaining said filaments in a viscous state adapted to enable them to be formed into increasingly thinner fibers;
a fixed blowing crown (16), generating a compressed-airflow (15); and
at least one second blowing crown (8), placed under the annular burner (6), to generate a second flow (9) active as a stretching means for the glass filaments coming out of the rotor (3); wherein said second blower unit (8) is movable to different operating configurations to vary the direction of the second flow (9) or the point of incidence between the second flow (9) and the fibers coming out of the rotor (3).

2. A device as claimed in claim 1, wherein the second blower unit (8) comprises at least one flow-delivering nozzle (10) that is movable around a respective transverse axis (B).

3. A device as claimed in claim 2, wherein the second blower unit (8) comprises a plurality of nozzles (10) disposed in mutual side by side relationship along a circular path (P) concentric with the rotation axis (A) of said rotor (3); said rotation axis (B) of each nozzle (10) being tangential to said circular path (P).

4. A device as claimed in claim 3, wherein said second flow (9) is made up of the flows generated by each nozzle (10); said second flow (9) having a substantially conical overall conformation converging downwardly.

5. A device as claimed in claim 4, wherein it further comprises actuating means for said nozzles (10) to move the nozzles (10) in a coordinated manner and in synchronism with each other, said movements of the nozzles (10) varying the angle of the flow generated by each nozzle (10) relative to the rotation axis (A).

6. A device as claimed in claim 5, wherein the fibering device further comprises a substantially annular supporting member (12) to support each of said nozzles (10), said supporting member (12) being movable along a direction parallel to the rotation axis (A) of said rotor (3) close to/away from the annular burner (6).

7. A device as claimed in claim 1, wherein the fibering device further comprises a compressed-air source (13) associated with said second blower unit (8) to generate the second air flow (9) under pressure.

8. A device as claimed in claim 1, wherein the annular burner (6) comprises a chamber of annular shape as well, disposed above said rotor (3) and having an outlet (6a) for the high-temperature flow (7) of burnt gasses substantially parallel to the rotation axis (A) of the rotor (3) and directed to the primary filaments coming out of the rotor (3).

9. A device as claimed in claim 8, wherein the fibering device comprises a blower (14) disposed between the burnt gas outlet (6a) and the blower (8) to generate a compressed air flow (15) directed downwardly and towards the rotation axis (A) of the rotor (3); said flow (15) being active on the primary filaments coming out of the rotor (3).

10. A device as claimed in claim 9, wherein said blower (14) comprises an annular chamber (16) having an outlet for the flow (15); said outlet being adjacent to and concentric with the burnt gas outlet (6a) of the burner (6).

11. A device as claimed in claim 9, wherein the ratio of the angle [β] defined between the first flow (15) and the rotation axis (A) to the angle [α] defined between the second flow (9) and the rotation axis (A) is smaller than or equal to 0.6 to produce short and thick fibers.

12. A device as claimed in claim 9, wherein said second flow (9) can be moved until it strikes on the fiber coming out of the rotor at a point coincident with the point of incidence of the first flow (15).

13. A method of making fibers comprising the following steps:
feeding a rotor (3) driven in rotation with melted glass to a temperature corresponding to the right viscosity to enable said melted glass to be reduced into fibers (4);
obtaining discharge of the glass in the form of primary filaments from a predetermined number of holes (5) present in the rotor (3) itself;
generating a high-temperature flow (7) of burnt gases active on said filaments coming out of the rotor (3) to maintain them to such a viscous state that reduction into fibers is allowed;
carrying out a first thinning operation through a blower unit (14) generating a first compressed air flow (15) acting on the primary filaments;
generating a second flow (9) also active on the fiber material; characterised in that the method further comprises the step of modifying the direction of the second flow (9) or the point of incidence between the second flow (9) itself and the fibers coming out of the rotor (3).

14. A method as claimed in claim 13, wherein the step of modifying the direction of the second flow (9) is obtained by driving in rotation a second blower unit (8) around an axis (B) thereof transverse to a rotation axis (A) of the rotor (3).

15. A method as claimed in claim 14, wherein said step of driving the second blower unit (8) in rotation comprises the sub-step of rotating a plurality of flow-delivering nozzles (10); each nozzle (10) rotating about a respective axis (B) tangent to a circular path (P) coaxial with the rotation axis (A) of the rotor.

16. A method as claimed in claim 15, wherein said nozzles (10) are rotated in a coordinated manner and in synchronism to change the direction of the second flow (9) defined by the flows generated by each individual nozzle (10).

17. A method as claimed in claim 13 wherein the burnt gas flow (7) is a high-temperature gas flow directed downwards along a direction parallel to the rotation axis (A) of the rotor (3), and in that the second flow (9) is a compressed air flow directed towards the rotation axis (A) of the rotor (3).

18. A method as claimed in claim 14, wherein the method further comprises the step of moving said second blower unit (8) along a direction parallel to the rotation axis (A) of the rotor.

19. A method as claimed in claim 13, wherein the method further comprises the step of generating a first flow (15) by means of a blower unit (14); said flow (15) being incident on the fibers coming out of the rotor (3) and being disposed between the burnt gas flow (7) and the second flow (9).
